(19) United States
(12) Patent Application Publication
(10) Pub. No.: US 2023/0027568 A1
(43) Pub. Date: Jan. 26, 2023

(54) METHOD OF PRODUCING COPPER OXIDE POWDER, AND COPPER OXIDE POWDER

(71) Applicant: MITSUBISHI MATERIALS CORPORATION, Tokyo (JP)

(72) Inventors: Kyoka Susuki, Naka-shi (JP); Mami Watanabe, Naka-shi (JP); Tomohiko Yamaguchi, Naka-shi (JP); Kiyotaka Nakaya, Naka-shi (JP)

(73) Assignee: MITSUBISHI MATERIALS CORPORATION, Tokyo (JP)

(21) Appl. No.: 17/782,535

(22) PCT Filed: Dec. 4, 2020
(86) PCT No.: PCT/JP2020/045167

§ 371 Date: Jun. 3, 2022

(30) Foreign Application Priority Data
Dec. 6, 2019 (JP) 2019-220822

(51) Int. Cl. C25D 3/38; C01G 3/02

(52) U.S. Cl. CPC C25D 3/38; C01G 3/02; C01P 2006/80

(57) ABSTRACT

A method of producing copper oxide powder includes a high-purity copper acidic solution preparation step (S01) of preparing an acidic solution containing 99.99% by mass or more of copper regarding metal components as 100% by mass, an organic acid salt addition step (S02) of adding an organic acid salt to this high-purity copper acidic solution, an organic acid copper production step (S03) of generating an organic acid copper by reacting the added organic acid salt with copper ions, an organic acid copper recovery step (S04) of recovering the obtained organic acid copper, and a heating step (S05) of forming copper oxide powder by heating the recovered organic acid copper, in which the organic acid forming the organic acid salt has 10 or less carbon atoms, and copper oxide powder.

### TECHNICAL FIELD

The present invention relates to a method of producing copper oxide powder, used, for example, as a supply source of copper ions in the electroplating of copper, and to a copper oxide powder.

Priority is claimed on Japanese Patent Application No. 2019-220822, filed on 6 Dec. 2019, the content of which is incorporated herein by reference.

### BACKGROUND ART

In the related art, in printed wiring boards such as mobile phones and computers and in circuit boards on which semiconductor elements and the like are mounted, wiring and circuits are formed by the copper plating method.

As a method of carrying out copper plating on printed wiring boards and circuit boards, electroplating is widely used in which, in a plating tank storing a plating solution such as a dilute sulphuric acidic solution containing copper ions, copper is immersed as a soluble anode and the printed wiring board, circuit board or the like is immersed as a cathode and electricity is passed through these anodes and cathodes. In electroplating using a soluble anode in this manner, the copper used as the anode dissolves into the dilute sulphuric acidic solution to form copper ions and copper is electro-deposited on the surface of the printed wiring board, circuit board, or the like used as the cathode. That is, the copper anodes for plating are dissolved by electrolysis.

In addition, electroplating is also widely used in which an insoluble anode coated with iridium oxide, platinum, or the like is immersed in a plating tank instead of the soluble anode. In this case, it is necessary to supply copper ions with respect to the plating solution in the plating tank by dissolving copper in a sulphuric acidic solution or the like. Here, in a case of dissolving copper in a sulphuric acidic solution or the like, examples thereof include methods using electrolysis or methods using a chemical reaction.

Copper oxide powder is used as a supply source of copper ions when performing such electroplating, as disclosed, for example, in Patent Documents 1 and 2.

Here, Patent Document 1 discloses a method of producing copper oxide by dissolving metal copper in a copper etching effluent in which the main components are copper chloride and hydrochloric acid, depositing a mixture including copper hydroxide to be separated as a solid, and mixing the result with an alkaline agent.

In addition, Patent Document 2 discloses a method of producing copper oxide by preparing a cuprammonium solution by dissolving solid copper in an ammonia solution and supplying carbon dioxide thereto, preparing basic copper carbonate by performing an ammonia distillation reaction with respect to the cuprammonium solution, and heating the basic copper carbonate.

### CITATION LIST

### Patent Documents

[Patent Document 1]
Japanese Unexamined Patent Application, First Publication No. 2008-162823 (A)

[Patent Document 2]
Japanese Unexamined Patent Application, First Publication No. 2015-157741 (A)

### SUMMARY OF INVENTION

### Technical Problem

Recently, progress has been made regarding the fine-patterning of wiring and circuits and there is a demand to reduce the resistance of such wiring and circuits beyond that in the related art. Here, in wiring and circuits formed by copper plating, the presence of crystal grain boundaries increases resistance. For this reason, there is a demand to coarsen the crystal grain size in the plating film by reducing the amount of impurities in the plating solution to increase the purity of the copper. In addition, reducing the amount of impurities in the plating solution makes it possible to suppress the increase in wiring resistance and the generation of electromigration due to impurities.

In addition, when sodium is mixed into a plating film, the surface properties and characteristics of the plating film are significantly decreased, thus, there is a demand to reduce the amount of sodium included in the plating solution.

Here, in a case where copper etching effluent is used, as described in Patent Document 1, since a large number of metal impurities other than copper are present in the copper etching effluent, there was a concern that a large number of impurities may be present in the produced copper oxide. In addition, in a case where sodium carbonate or sodium hydroxide was used as an alkaline agent, there was a concern that a large amount of sodium may be included as an impurity. For this reason, in a case where the copper oxide powder described in Patent Document 1 was supplied to the plating solution, the amount of impurities and the amount of sodium in the plating solution increased and it was not possible to deposit a highly purified copper plated film.

In addition, in a case where solid copper was dissolved in an ammonia solution and carbon dioxide was supplied to prepare a cuprammonium solution, as described in Patent Document 2, there was a concern that copper ions may form complexes with ammonia in the alkaline solution and it may not be possible to efficiently produce copper oxide. In addition, when the purity of the dissolved solid copper was low, there was a concern that a large number of impurities may be present in the produced copper oxide. Furthermore, there was a problem in that the copper oxide powder produced in Patent Document 2 had poor solubility and did not dissolve quickly in the plating solution.

The present invention was created in view of the circumstances described above and has an object of providing a method of producing copper oxide powder which is able to efficiently produce copper oxide powder with low impurity content and excellent solubility and suitable as a copper ion supply source for a copper plating solution, and copper oxide powder.

### Solution to Problem

In order to solve these problems and achieve the objectives described above, a method of producing copper oxide powder (referred to below as the “method of producing copper oxide powder of the present invention”) of one aspect of the present invention includes a high-purity copper acidic solution preparation step of preparing an acidic solution containing 99.99% by mass or more of copper regarding metal components as 100% by mass, an organic acid salt addition step of adding an organic acid salt to the high-purity copper acidic solution, an organic acid copper production step of producing an organic acid copper by reacting the added organic acid salt with copper ions, an organic acid copper recovery step of recovering the obtained organic acid copper, and a heating step of forming a copper oxide powder by heating the recovered organic acid copper, in which an organic acid forming the organic acid salt has 10 or less carbon atoms.

In the method of producing copper oxide powder with this configuration, a high-purity copper acidic solution containing 99.99% by mass or more of copper when the metal component is taken as 100% by mass is used, thus, it is possible to suppress the mixing in of impurities from the high-purity copper acidic solution.

In addition, the method is provided with an organic acid salt addition step of adding an organic acid salt to a high-purity copper acidic solution and an organic acid copper production step of producing an organic acid copper by reacting the added organic acid salt with copper ions, thus, it is possible to generate organic acid copper in an acidic solution state. For this reason, for example, even in a case of using organic acid ammonium salts as organic acid salts, it is possible to suppress copper ions from forming complexes with ammonia.

Furthermore, the method is provided with an organic acid copper recovery step of recovering the obtained organic acid copper and a heating step of forming copper oxide by heating the recovered organic acid copper, thus, it is possible to form the organic acid copper into copper oxide without using alkali metal hydroxides such as sodium hydroxide and to suppress mixing in of sodium as an impurity.

Since the number of carbon atoms of the organic acid forming the organic acid salt is set to 10 or less, it is possible to efficiently obtain copper oxide in the heating step.

In a copper oxide powder of another aspect of the present invention (referred to below as “copper oxide powder of the present invention”), a content of sodium which is an impurity is 5 mass ppm or less regarding metal components as 100% by mass.

According to the copper oxide powder with this configuration, the content of sodium which is an impurity is limited as described above, thus, in a case where this copper oxide powder is used as a copper ion supply source for a plating solution, it is possible to suppress increases in the sodium concentration in the plating solution.

Here, in the copper oxide powder of the present invention, a total content of metal impurities is preferably 30 mass ppm or less regarding the metal components as 100% by mass.

In this case, since the total content of metal impurities is limited as described above, in a case where this copper oxide powder is used as a copper ion supply source for the plating solution, it is possible to suppress the amount of metal impurities in the plating solution from rising.

### Advantageous Effects of Invention

According to the present invention, it is possible to provide a method of producing copper oxide powder which is able to efficiently produce copper oxide powder with low impurity content and excellent solubility and suitable as a copper ion supply source for a copper plating solution, and a copper oxide powder.

### BRIEF DESCRIPTION OF DRAWINGS

FIG. 1 is a flow diagram showing a method of producing copper oxide powder, which is an embodiment of the present invention.

### DESCRIPTION OF EMBODIMENTS

A description will be given below of the embodiments of the present invention.

Each of the embodiments shown below is specifically described to give a better understanding of the gist of the invention and does not limit the present invention unless otherwise specified. In addition, for the sake of convenience, the drawings used in the following descriptions may show enlarged portions of the essential parts in order to make the features of the present invention easier to understand and the dimensional ratios and the like of each constituent component may not always be the same as in practice.

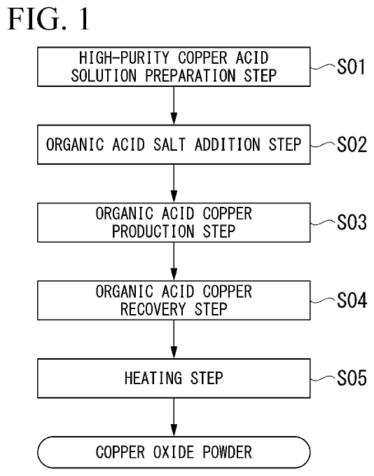

As shown in the flow diagram in FIG. 1, the method of producing copper oxide powder of the present embodiment is provided with a high-purity copper acidic solution preparation step S01 of preparing an acidic solution containing 99.99% by mass or more of copper regarding metal components as 100% by mass, an organic acid salt addition step S02 of adding an organic acid salt to this high-purity copper acidic solution, an organic acid copper production step S03 of generating an organic acid copper by reacting the added organic acid salt with copper ions, an organic acid copper recovery step S04 of recovering the obtained organic acid copper, and a heating step S05 of forming a copper oxide powder by heating the recovered organic acid copper.

(High-Purity Copper Acidic Solution Preparation Step S01)

First, a high-purity copper acidic solution containing 99.99% by mass or more of copper regarding metal components as 100% by mass is prepared.

It is possible to obtain this high-purity copper acidic solution by dissolving 4N copper with a purity of 99.99% by mass or more in an acidic solution such as nitric acid or sulphuric acid and, for example, it is possible to use a high-purity copper acidic solution for producing 6N copper with a purity of 99.9999% by mass or more.

(Organic Acid Salt Addition Step S02)

Next, organic acid salts are added to this high-purity copper acidic solution. For example, as organic acids forming organic acid salts, it is possible to use acetic acid, lactic acid, tartaric acid, citric acid, and the like.

Here, as the organic acids forming the organic acid salt, organic acids with 10 or less carbon atoms are used. The number of carbon atoms of the organic acid forming the organic acid salt is preferably 6 or less.

(Organic Acid Copper Production Step S03)

Next, the added organic acid salts react with the copper ions to generate organic acid copper. The organic acid copper is generated as a precipitate.

Here, in the organic acid copper production step S03, in order to accelerate the reaction between the organic acid salt and the copper ions, the high-purity copper acidic solution to which the organic acid salt is added is preferably heated to a temperature of, for example, 30° C. or higher and 80° C. or lower and held in this range for 0.5 hours or more and 2 hours or less.

(Organic Acid Copper Recovery Step S04)

Next, the organic acid copper generated as a precipitate is separated from the high-purity copper acidic solution and the result is dried to recover the organic acid copper.

It is possible to use ordinarily used methods such as filtration and centrifugation for the separation.

(Heating Step S05)

Next, the recovered organic acid copper is heated to obtain a copper oxide powder. It is possible to perform the heating step S05 in an oxidizing atmosphere. The atmosphere may be an air atmosphere or, for example, the oxygen concentration in a reactor may be in a range of 10 vol % or more and 20 vol % or less.

Here, the heating temperature in the heating step S05 is preferably in a range of 250° C. or higher and 450° C. or lower and the holding time at the heating temperature is preferably in a range of 0.5 hours or more and 12 hours or less.

Through the steps described above, the copper oxide powder of the present embodiment is produced.

In the copper oxide powder of the present embodiment, the content of sodium which is an impurity is 5 mass ppm or less regarding metal components as 100% by mass.

In addition, in the copper oxide powder of the present embodiment, the total content of the metal impurities is preferably 30 mass ppm or less regarding metal components as 100% by mass.

According to the method of producing copper oxide powder of the present embodiment formed as described above, a high-purity copper acidic solution containing 99.99% by mass or more of copper when the metal component is taken as 100% by mass is used, thus, it is possible to suppress the mixing in of impurities from the high-purity copper acidic solution.

In addition, there is provided the organic acid copper recovery step S04 of recovering the obtained organic acid copper and the heating step S05 of forming copper oxide by heating the recovered organic acid copper, thus, it is possible to form the organic acid copper into copper oxide without using an alkali and to suppress sodium from being mixed in as an impurity.

Thus, it is possible to produce copper oxide powder with low sodium and other metal impurities.

In addition, according to the method of producing copper oxide powder of the present embodiment, there are provided the organic acid salt addition step S02 of adding an organic acid salt to a high-purity copper acidic solution and the organic acid copper production step S03 of generating an organic acid copper by reacting the added organic acid salt with copper ions, thus, it is possible to generate an organic acid copper in an acidic solution state. For this reason, for example, even in a case where ammonia is used as the organic acid salt, it is possible to suppress the copper ions from forming complexes with ammonia. Furthermore, it is possible to obtain a copper oxide powder with excellent solubility.

Furthermore, in the present embodiment, since an organic acid salt formed of an organic acid with 10 or less carbon atoms is used in the organic acid salt addition step S02, it is possible to obtain a copper oxide powder even when the heating temperature in the heating step S05 is in a range of 250° C. or higher and 450° C. or lower.

In addition, in the copper oxide powder of the present embodiment, the content of sodium which is an impurity is 5 mass ppm or less regarding the metal components as 100% by mass, thus, even in a case where this copper oxide powder is used as a copper ion supply source for the plating solution, it is possible to suppress increases in the sodium concentration in the plating solution. Thus, it is possible to stably deposit copper plated films with excellent surface properties and characteristics.

In the copper oxide powder of the present embodiment, in a case where the total content of metal impurities is 30 mass ppm or less regarding the metal components as 100% by mass, even in a case where this copper oxide powder is used as a copper ion supply source for the plating solution, it is possible to suppress increases in the amount of metal impurities in the plating solution. Thus, it is possible to deposit a copper plated film with high purity and to form wiring and circuits with a large crystal grain size and low resistance.

Although embodiments of the present invention are described above, the present invention is not limited thereto and it is possible to carry out appropriate modifications in a range which does not depart from the technical concept of the invention.

### EXAMPLES

A description will be given of confirmatory experiments performed to confirm the effectiveness of the present invention.

### Examples 1 to 5 and Comparative Examples 2 and 3

As a high-purity copper acidic solution, a high-purity copper acidic solution containing 99.99% by mass or more of copper when the metal component is taken as 100% by mass was prepared in which 4N copper (mass: 50 g) with a purity of 99.99% by mass or more was dissolved in a sulphuric acidic solution (concentration: 100 wt %).

To 2 L of this high-purity copper acidic solution, a solution of the organic acid salts shown in Table 1 was added. The result was heated and maintained at the temperatures shown in Table 1 and the organic acid salts were reacted with the copper ions to generate organic acid coppers.

The organic acid copper generated as a precipitate was separated by a (centrifugation) method and then the extracted organic acid copper was dried. Thereafter, the recovered organic acid copper was heated under the conditions shown in Table 1.

### Comparative Example 1

A copper etching effluent with copper chloride and hydrochloric acid as the main components was prepared as a copper acidic solution and a copper oxide powder was generated using the procedure described in Patent Document 1. Sodium hydroxide was used as the alkaline agent.

Component analysis and dissolution rate measurement were carried out as follows on the obtained copper oxide powder. The results are shown in Table 2.

(Component Analysis) For each metal element except K and Na, analysis was performed by inductively coupled plasma mass spectrometry (ICP-MS) and K and Na were analyzed by flame photometry. For metal component analysis, values at or below the detection limit were denoted as <1 and, when calculating the total content of metal impurities, <1 was calculated as 0. The analysis results are shown in Table 2.

(Dissolution Rate)

For the dissolution rate, when 0.3 g of a copper oxide powder was dissolved in 50 mL of an 80 g/L sulphuric acidic solution (sulphuric acid concentration 8 wt %), the time until it was no longer possible to visually confirm the copper oxide powder was evaluated as the ‘dissolution time’. In the time from before the copper oxide powder was introduced to when visual confirmation was no longer possible, a stirrer was used to perform stirring at a speed of 400 rpm.

TABLE 1

| | Organic acid salt | | Heating conditions | | Heating conditions | | | |
|---|---|---|---|---|---|---|---|---|
| | Type (carbon | Addition | Temperature | | | Heating | Holding time | |
| | atoms) | amount (g) | (° C.) | Time (min) | Atmosphere | temperature (° C.) | (hours) | Heating |
| Example 1 | Tri- | 12.2 | 70.0 | 30 | Air | 300 | 2 | Possible |
| | ammonium | | | | atmosphere | | | |
| | citrate (C:6) | | | | | | | |
| Example 2 | Ammonium | 14.1 | 60.0 | 40 | Air | 320 | 2 | Possible |
| | acetate (C:2) | | | | atmosphere | | | |
| Example 3 | Ammonium | 19.7 | 30.0 | 10 | Air | 250 | 2 | Possible |
| | lactate (C:2) | | | | atmosphere | | | |
| Example 4 | Ammonium | 14.2 | 70.0 | 30 | Air | 350 | 4 | Possible |
| | oxalate (C:2) | | | | atmosphere | | | |
| Example 5 | Ammonium | 18.6 | 80.0 | 90 | Air | 280 | 4 | Possible |
| | tartrate (C:4) | | | | atmosphere | | | |
| Comparative | Sodium hydroxide added to copper etching effluent | | | | | | | |
| Example 1 | | | | | | | | |
| Comparative | Ammonium | 30.5 | 90.0 | 80 | Air | 400 | 8 | Not possible |
| Example 2 | oleate (C: 17) | | | | atmosphere | | | |
| Comparative | Ammonium | 30.7 | 80.0 | 120 | Air | 450 | 10 | Not possible |
| Example 3 | stearate | | | | atmosphere | | | |
| | (C:18) | | | | | | | |

TABLE 2

| | Metal component analysis of copper | | | | | | | | |
|---|---|---|---|---|---|---|---|---|---|
| | oxide powder (mass ppm) | | | | | | | | |
| | | | | | | | | Total | |
| | | | | | | | | content of | Solubility |
| | | | | | | | | metal | Dissolution |
| | Zn | Ni | Fe | Pb | K | Na | Ag | impurities | time (sec) |
| Example 1 | <1 | <1 | 2 | 3 | <1 | 1 | 1 | 7 | 30 |
| Example 2 | <1 | 1 | 3 | 17 | <1 | 1 | 1 | 23 | 70 |
| Example 3 | <1 | <1 | <1 | 2 | <1 | <1 | 2 | 4 | 40 |
| Example 4 | 1 | <1 | 2 | <1 | <1 | 1 | 1 | 5 | 50 |
| Example 5 | 2 | 1 | 5 | 20 | <1 | <1 | 1 | 29 | 80 |
| Comparative | 34 | 93 | 6 | <1 | <1 | 470 | <1 | 603 | 140 |
| Example 1 | | | | | | | | | |
| Comparative | 1 | <1 | 4 | 17 | <1 | 1 | 2 | 25 | — |
| Example 2 | | | | | | | | | |
| Comparative | <1 | 1 | 3 | 13 | <1 | <1 | 1 | 18 | — |
| Example 3 | | | | | | | | | |

In Comparative Example 1, in which sodium hydroxide was added to a copper etching effluent, the content of Na which was an impurity was extremely high at 470 mass ppm and the total content of the metal elements which were impurities was also extremely high at 603 mass ppm. Furthermore, the dissolution time was long at 140 seconds and the solubility was poor.

In Comparative Example 2, in which ammonium oleate with 17 carbon atoms was used as the organic acid salt in a high-purity copper acidic solution containing 99.99% by mass or more of copper when the metal component was taken as 100% by mass, and in Comparative Example 3, in which ammonium stearate with 18 carbon atoms was used as the organic acid salt, it was not possible to obtain a copper oxide powder even after heating.

In contrast, in Examples 1 to 5, in which organic acid salts with 10 or less carbon atoms were added to a high-purity copper acidic solution containing 99.99% by mass or more of copper when the metal component was taken as 100% by mass, it was possible to obtain a copper oxide powder by the heating step.

In addition, in the obtained copper oxide powder, the content of Na and the total content of metal elements, which are impurities, were kept low. Furthermore, the dissolution time was also short and the solubility was also good.

From the above results, it was confirmed that, according to the present invention, it is possible to provide a method of producing copper oxide powder which is able to efficiently produce copper oxide powder with low impurity content and excellent solubility and suitable as a copper ion supply source for a copper plating solution, and a copper oxide powder.

### INDUSTRIAL APPLICABILITY

It is possible to provide a method of producing copper oxide powder which is able to efficiently produce copper oxide powder with low impurity content and excellent solubility and suitable as a copper ion supply source for a copper plating solution, and copper oxide powder.

What is claimed is:

1. A method of producing copper oxide powder comprising:
a high-purity copper acidic solution preparation step of preparing an acidic solution containing 99.99% by mass or more of copper regarding metal components as 100% by mass;
an organic acid salt addition step of adding an organic acid salt to the high-purity copper acidic solution;
an organic acid copper production step of producing an organic acid copper by reacting the added organic acid salt with copper ions;
an organic acid copper recovery step of recovering the obtained organic acid copper; and
a heating step of forming a copper oxide powder by heating the recovered organic acid copper,
wherein an organic acid forming the organic acid salt has 10 or less carbon atoms.

2. A copper oxide powder wherein a content of sodium which is an impurity is 5 mass ppm or less regarding metal components as 100% by mass.

3. A Copper oxide powder according to claim 2,
wherein a total content of metal impurities is 30 mass ppm or less regarding the metal components as 100% by mass.
